(19) United States
(12) Patent Application Publication
(10) Pub. No.: US 2007/0208518 A1
(43) Pub. Date: Sep. 6, 2007

(54) User interface for presentation of genomic data

(76) Inventors: David Ben Gordon, Somerville, MA (US); Andrew Payne, Lincoln, MA (US); Brett Chevalier, Malden, MA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/365,101

(22) Filed: Mar. 1, 2006

(51) Int. Cl. G06F 19/00

(52) U.S. Cl. 702/20

(57) ABSTRACT

A user interface for presentation of genomic data is presented herein. The user interface presents a list of genomic locations of interest. Selection of one of the selected locations in the list causes a region of the display presenting a span of genomic data in graphical fashion to alter the presented span to include the selected genomic location.

### BACKGROUND

DNA Microarrays are used to identify DNA sequences that are enriched in a biological sample. Depending on how this sample is prepared, identification of the sequences can provide measurements of biological events ranging from gene expression to chromatin structure. One such application is chromatin immunoprecipiataion, in which microarrays are used to determine locations in the genome that appear to be in physical contact with a protein that is regulating the expression of a gene.

Briefly, a DNA microarray may be embodied on a substrate that includes a plurality (typically thousands) of regions bearing particular chemical moities. Each region bearing a particular chemical moiety may be referred to as a “feature,” consisting of a quantity of “probes.” The chemical composition of each probe is chosen so as to include single-strand nucleotide sequences corresponding to a given location within the genome. In other words, a first feature may include single-strand nucleotide sequences of bases number one through sixty of a first chromosome, and a second feature may include single-strand nucleotide sequences of bases number sixty-one through one-hundred and twenty, and so on. Such an array is often referred to as a “tiling array.” The genomic regions represented by the various features on a tiling array may overlap, concatenate, or exhibit gaps. For example, a genomic gap of 200-300 base pairs be exhibited from feature to feature.

A target single-strand nucleotide sequence (referred to herein as a “target”) known to correspond to a binding site of a transcription factor, or protein, or other activity of interest is hybridized with the array, and therefore commingles with the various probes thereon. Upon hybridization, the target binds to various probes on the array with various binding strengths, depending upon how closely each probe resembles the target's compliment. Before hybridization, the targets are typically treated (with any number of existing methods) to tag the targets with dyes that fluoresce at a specific wavelength. After hybridization, a fluorescence reader, for example, may be used to measure the strength of the signal emitted from the probes of each of the features, which represent the amount of target material hybridized to that probe, which in turn represents the relative strength of binding between the probe and target. In other words, the reader obtains a signal strength corresponding to each feature on the array. Typically, the reader measures two signal strengths for each feature: (1) the strength of a signal at a first wavelength that indicates the strength of the binding between the probes of a given feature and a control target; and (2) the strength of a signal at a second wavelength that indicates the strength of the binding between the probes of the aforementioned given feature and a test target. The ratio between the two signal strengths indicates the extent by which the test target differs from the control, and may indicate that a particular region of the genome is of interest. Thus, a high ratio between signal strengths from a test target and a control target (test:control) typically indicates a region of interest. The ratio is one of a number of possible ways of measuring the “enrichment” of the test target. Others include so-called “one-color” measurements (test), difference (test-control), or variants of these measures that are adjusted using estimates of the error in the measurements (test-control)/error.

It has proven to be difficult to present the aforementioned measured enrichments corresponding to the various features on an array. Because on the order of 80,000 features may be contained on an array (an array may contain a greater or lesser number of features) or set of arrays analyzed together as a single array, the enrichments corresponding to each of the features cannot be presented on the user interface at the same time. Thus, the user interface should provide for rapid location of regions of interest, and should present the measured enrichment information in such a way that it is meaningful to the individual viewing the user interface.

### SUMMARY

In general terms, this document is directed to a user interface for presentation of genomic data. The user interface allows regions of interest to be quickly located, may allow for contextual information to be presented while viewing of a particular region of interest, and may allow for more than one dimension of data to be viewed without resort to a separate window.

According to one embodiment, a computer system for presentation of genomic data includes a processor, a display in communication with the processor, and a memory in communication with the processor. The memory stores a set of instructions, which, when executed by the processor, cause the display to present a user interface including a list of locations within a genome that have been identified as being of interest. Each listed location is selectable. The user interface also presents a genomic data display area that presents genomic data corresponding to a location selected from said list of locations.

According to another embodiment, a computerized method includes presenting a list of genomic locations that have been identified as being of interest. Each listed genomic location is selectable. Selection of a genomic location from the list is detected. Genomic corresponding to the selected genomic location and to genomic locations preceding and following the selected genomic location is presented in a genomic data display area.

According to yet another embodiment, a computer-readable medium, stores a set of instructions, which when executed by a computer, causes presentation of a list of genomic locations that have been identified as being of interest. Each listed genomic location is selectable. Detection of a selection of a genomic location from the list is also caused. Presentation, in a genomic data display area, of genomic data corresponding to the selected genomic location and to genomic locations preceding and following the selected genomic location is also caused.

According to yet another embodiment, a method includes viewing a list of genomic locations that have been identified as being of interest. Each listed genomic location is selectable. A genomic location is selected from the list. Genomic data corresponding to the selected genomic location and to genomic locations preceding and following the selected genomic location is viewed in a genomic data display area.

### BRIEF DESCRIPTION OF THE DRAWINGS

FIG. 1 depicts a computer that is configured to access a data store containing genomic data, and is further configured to present the data via a user interface.

FIG. 2 depicts an exemplary embodiment of the user interface presented by the computer system of FIG. 1.

FIG. 3 depicts an exemplary embodiment of the genomic display area, with a region of the genome being collapsed.

FIG. 4 depicts another exemplary embodiment of the user interface presented by the computer system of FIG. 1.

### DETAILED DESCRIPTION

### DEFINITIONS

The term “gene” refers to a unit of hereditary information, which is a portion of DNA containing information required to determine a protein's amino acid sequence.

“Gene expression” refers to the level to which a gene is transcribed to form messenger RNA molecules, prior to protein synthesis.

“Gene expression analysis” refers to analysis methods used to understand the function and control of genes by determining the expression levels of nucleic acids (i.e. DNA or RNA) or proteins. For example, gene expression analysis is used for the identification of novel genes, the correlation of gene expression to a particular physiological condition, screening for disease predisposition, identifying the effect of a particular agent on cellular gene expression, etc., as described in U.S. Pat. No. 6,989,267, which is incorporated herein by reference.

A “microarray” or “DNA microarray” is a high-throughput hybridization technology that allows biologists to probe the activities of thousands of genes under diverse experimental conditions. Microarrays function by selective binding (hybridization) of probe DNA sequences on a microarray chip to fluorescently-tagged messenger RNA fragments from a biological sample. The amount of fluorescence detected at a probe position can be an indicator of the relative expression of the gene bound by that probe. Any given microarray may employ a single channel or single color platform on which only a single experiment is run, or a multi channel or multi color platform on which multiple experiments are run. A common multi channel example is a two channel platform where one experiment is color-coded with a first color (e.g., color-coded green) and the other channel is color-coded with a second color (e.g., color-coded red). Such an arrangement may be used to simultaneously run a reference sample (experiment) and a test sample (experiment) and differential expression values may be calculated from a comparison of the results.

“Chromosome” refers to a continuous, piece of DNA, which may contain many genes, regulatory elements, and other intervening nucleotide sequences.

“Protein expression” refers to the level, amount and time-course of one or more proteins in a particular cell, tissue or organism.

“Protein expression analysis” refers to methods for isolating, identifying, and/or quanitfying proteins to determine their function and role in various physiological processes. Examples of protein expression analysis are described in Published U.S. Patent Application Nos. 20050233337 and 20040115722, which is hereby incorporated by reference.

“Location analysis” refers to analysis methods used to determine the locus (i.e. a fixed position in a genome) corresponding to a biological phenomenon of interest. An example of location analysis is described in U.S. Pat. No. 6,410,243, which is incorporated by reference herein.

“Comparative genomic hybridization” refers to a method of analysis of copy number changes (e.g., gains or losses) in the DNA content of a tissue of interest. Examples of comparative genomic hybridization are described in Published U.S. Patent Application Nos. 20050244881, 20050233339, and 20050233338, which are hereby incorporated by reference.

“Genomic location” or “location” refers to a base pair coordinate or range of base pair coordinates on a genome, and/or information sufficient to arrive at the aforementioned base pair coordinate or range of base pair coordinates.

“Genomic data” is a term referring to information concerning cellular phenomenon and/or events of interest, including, without limitation, information obtained from gene expression analysis, protein expression analysis, location analysis, and/or comparative genomic hybridization.

“Genomic data display area” refers to a region of a display wherein genomic data is presented graphically.

“Vicinity” a genomic feature is in the vicinity of a genomic location, if fewer than a specified number of bases are interposed between the genomic feature and the genomic location.

“Supplemental source of genomic information” refers to a source of genomic information other than a source prepared or controlled by the user of the interface described herein.

“Hyperlink” is a reference to a hypertext document or resource that is fetched upon selection of the reference.

“Selectable” an object presented on a user interface is selectable, if an event is initiated by designation of the object with an input device.

“Curve” refers to a probability density function that relays information regarding the probability that a given genomic location corresponds to a phenomenon under study, or any other function standing in relation to the aforementioned probability density function, e.g., a cumulative density function.

### Embodiments

Various embodiments presented herein will be described in detail with reference to the drawings, wherein like reference numerals represent like parts and assemblies throughout the several views. Reference to various embodiments should not be construed as limiting the scope of covered subject matter, which is limited only by the scope of the claims attached hereto. Additionally, any examples set forth in this specification are not intended to be limiting and merely set forth some of the many possible embodiments.

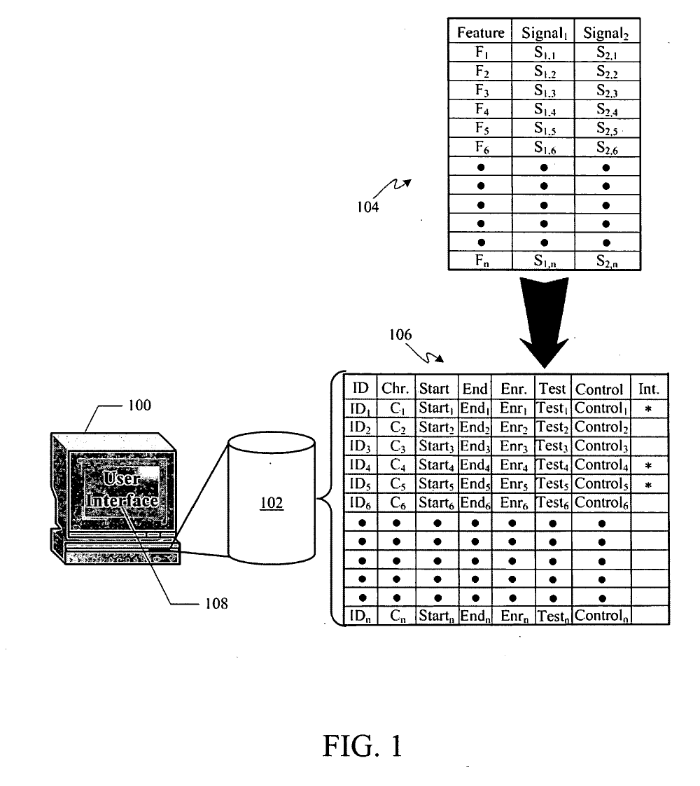

FIG. 1 depicts a computer 100 that is programmed to present a user interface for convenient viewing of genomic data. The computer 100 includes the components typically found in a general-purpose computer, i.e., it includes a processor that is coupled to one or more stages of memory that store software and data. The processor communicates, via an input/output (I/O) bus, with various input, output, and communication devices, including a display, such as a monitor, a keyboard, a mouse, and/or speakers, to name a few such devices. Various peripheral devices may also communicate with the processor via the I/O bus, including a network interface card, a hard disc drive, or other mass data storage device, removable media drives, such as a CD ROM drive or a DVD drive (which may be both readable and writable), and/or a wireless interface. It is understood that computers presently employ many chip sets and architectures. The computer 100 broadly represents all such chip sets and architectures, and the various embodiments of the user interface described herein may execute on all such chip sets and architectures.

The processor in the computer 100 is able to access, either directly or indirectly, a data store 102. The data store 102 may be stored in a memory device(s) within the computer 100 or managed by the computer 100. For example, the data store 102 may be embodied within random access memory RAM chip(s) within the computer 100, or may be embodied within a mass storage device(s) within the computer 100 (of course, the data store 102 may be embodied on both the RAM chip(s) and mass storage device(s) within the computer 100). Further, the data store 102 may be embodied in a computing system, memory device, or network storage device, that is accessible to the computer 100 via a network, such as a local area network (LAN) that is coupled to the Internet, for example.

The data store 102 may be embodied as a database, such as a relational database or an object-oriented database, or a file or set of files. For example, the data store may be embodied as a relational database, such as a SQL server executing either locally or on a remote computer accessible by the computer 100 via a network, or as an object-oriented database, such as an Objectivity server (again, executing either locally or on a remote computer). Alternatively, the data store 102 may be embodied as any other form of software unit fit for storing and providing access to data, such as genomic data.

The data store 102 stores genomic data that is accessible to the computer 100. The genomic data may originate from any source. For the sake of illustration, the genomic data is described herein as originating from a fluorescence reader (not depicted) that has measured two signals, a test signal and a control signal, from each of a plurality of features (e.g., 80,000 features) on a tiling array. (Additionally, as described in more detail, below, the genomic data may include data from other sources, such as sources available over the Internet). As mentioned previously, a tiling array is a type of microarray where probes are not designed to target known genes or promoters, but simply laid down at relatively regular intervals along the length of the genome. Thus, for example, a first feature may include probes that are a single strand nucleotide sequence of bases number one through sixty of chromosome number one, a second feature may include probes that are a single strand nucleotide sequence of bases number two-hundred and one through two-hundred and sixty of chromosome number one, and so on. Thus, the tiling array generally represents the length of the genome.

The aforementioned fluorescence reader generates a data set 104 such that, for each feature (feature_{i, i=1 to n}), there exists two corresponding measured signal strengths (S_{1,i} and S_{2,i})—the first signal strength, S_{1,i}, having been derived from the test target, and the second signal strength, S_{2,i}, having been derived from the reference target. The reader may also generate data describing the confidence in the measurements of the signal strength. The data set 104 is analyzed by a region-of-interest determining algorithm (of which many are known in the art), which observes the signal strengths corresponding to the various regions within the genome, and flags various areas of the genome as being of interest. Therefore, the data set 104 is translated into a second data set 106. (In practice, the data set 104 may include other data, such as a feature ID, a chromosome and a coordinate of the genomic region corresponding to a feature.)

The second data set 106 is depicted as being organized in rows and columns. Each row corresponds to a feature on the microarray, which, in turn, corresponds to an area within the genome. Thus, each row includes eight units of data: (1) an identifier of the genomic region corresponding to the row; (2) the chromosome in which genomic region is situated; (3) the number of the base at which the genomic region begins; (4) the number of the base at which the genomic region ends; (5) the enrichment, such as the ratio of the two signal strengths corresponding to the genomic region; (6) the test signal strength corresponding to the genomic region; (7) the control signal strength corresponding to the genomic regions; and (8) and indication of whether the genomic region is of interest (in FIG. 1, the genomic region corresponding to a row has been indicated as being of interest, if it contains an asterisk in the column labeled “Int.”) The second data set 106 is stored in the aforementioned data store 102. The second data set 106 may also contain addition information, such as alternative measurements of enrichment or estimates in the error in the measurement of the enrichments.

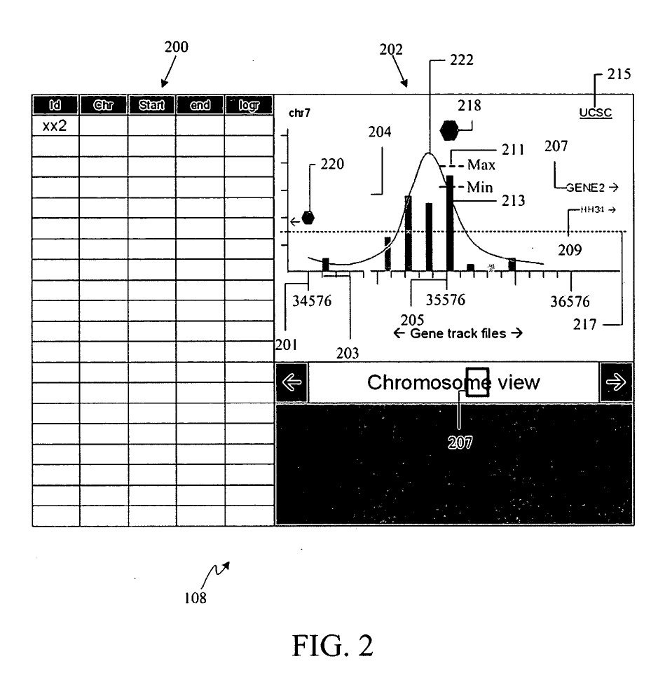

The computer 100 accesses the second data set 106, and presents the data via a graphical user interface 108. The computer 100 is programmed with a set of instructions for presenting the graphical user interface 108, embodiments of which are described below. Therefore, the software embodying the user interface may be stored on a computer-readable medium, such as a hard disc drive or a memory chip, for example, and is executed by the processor, in order to present the user interface described herein, below. Of course, the software providing the user interface may reside upon an application server/and or web server that is accessed by a remote computer. The remote computer is then served the user interface across a network, such as the Internet. The software embodying the user interface may be downloaded in on the fly by a computer networked to a web server hosting the software (the software is then executed by the downloading computer). An exemplary embodiment of the user interface 108 is depicted in FIG. 2.

To use the user interface of FIG. 2, an operator performs a genetic analysis, such a protein expression analysis, gene expression analysis, location analysis, and/or comparative genomic hybridization, as described in the various patents incorporated by reference above. As a result of performing such an analysis, a data set, such as the first data set 104 is created. The operator may then import the data set 104, or another data set derived from the aforementioned data set 104, into a computing environment, so that it is accessible by the software embodying the user interface 108. The user interface 108 then accesses the data set and presents the data therein, as described below. The operator may then view the data via the user interface 108.

As can be seen from FIG. 2, the user interface 108 includes a list 200 that identifies genomic regions that have been identified as being of interest. The list 200 is organized in rows and columns, with each row corresponding to a row from the second data set 106 (FIG. 1) that has been identified as being an area of interest (i.e., has been flagged with an asterisk in FIG. 1). In other words, the list 200 is composed of all of the rows from the second data set 106 that have been identified as revealing an area of interest. According to other embodiments, the list 200 includes all of the data from the second data set 106, with the rows corresponding to an area of interest being highlighted.

The user interface 108 also includes a genomic display area 202. The genomic display area 202 presents the genomic data from the second data set 106 visually. According to some embodiments, the genomic display area 202 is organized as a Cartesian plane, with genomic location plotted along the x-axis, and enrichment, plotted in this example as the log ratio of signal strengths along the y-axis (log₂ [strength of test signal/strength of control signal]). The x-axis presents successive measured genomic regions between a starting base number and an ending base number. According to some embodiments, the x-axis includes a series of major and minor ticks. The first major tick is identified by reference numeral 201, and is labeled “34576.” The bar located at this tick indicates the log ratio of the signal strength corresponding to a location in the genome beginning at base number 34576 and ending at base number 34576+(k−1), where k represents the quantity of bases making up the single-strand nucleotide sequences of the probes in the various features of the microarray. For example, k may be equal to 60 in some embodiments. It is to be understood that the value assigned to k is a design choice that may, in principle, take on any value. Observation of FIG. 1 reveals that no bar is located at the first major tick 201, meaning that the ratio exhibited at that location in the genome is equal to one, which equates to a log ratio of zero. Immediately following the first major tick 201 is a first minor tick 203. Based on the fact that the second major tick 205 is labeled “35576,” and that nine minor ticks are interposed between the first and second major ticks 201 and 205, it follows that the bar 202 located at the first minor tick 203 indicates the log ratio of the signal strength corresponding to a location in the genome beginning at base number 34676 and ending at base number 34676+(k−1). Thus, in the embodiment of FIG. 1, each minor tick indicates a genomic span of 100 bases, while each major tick represents a genomic span of 1000 bases. According to some embodiments, the user interface 108 accesses “zoom” data value that permits selection of the genomic span represented by major and minor ticks.

According to some embodiments, the genomic distances represented by the major ticks 201 and 205 and minor ticks 203 are dependent on, and automatically adjusted for, how far the user has zoomed the view in or out. For example, if the user zooms “out” the display shown in FIG. 1, the major ticks may represent, for example, a genomic span of 200 bases instead of 100 bases.

According to some embodiments, each row of the list 200 is selectable. Upon selection, the row is highlighted, so as to indicate its selection. Selection of a row from the list 200 also may cause the view within the genomic display area 202 to change. For example, selection of a row in which the beginning base number is 647903, causes the second major tick 205 (i.e., the middle of the genomic display area) to be labeled 647903, and to therefore present a bar that indicates the log ratio of the signal strength corresponding to a location in the genome beginning at base number 647903 and ending at base number 647903+(k−1). Assuming the same level of zoom as presently shown in the embodiment depicted in FIG. 1, the first major tick 201 would be labeled 646903, and the third major tick would be labeled 648903, meaning that the genomic display area would present genomic data spanning a genomic range from base number 646903 to base number 648903+(k−1).

According to some embodiments, the genomic display area 202 also includes a scroll bar 207. The scroll bar 207 functions in the same manner as scroll bars that are ordinarily encountered in user interfaces. Moving the scroll bar 207 to the right, causes the genomic range presented in the genomic display area 202 to progress “up” the genome (the bases numbers presented in the genomic display area grow larger), while moving the scroll bar 207 to the left causes genomic range presented in the genomic display area 202 to progress “down” the genome (the bases numbers presented in the genomic display area grow smaller). According to some embodiments, upon adjusting the genomic range presented in the genomic display area 202 via the scroll bar 207, the newly presented genomic range is examined to determine if it contains a region of interest. If so, the row(s) in the list 200 corresponding to the region of interest presented within the genomic display area 202 is highlighted.

According to some embodiments, the size of the scroll bar 207 represents the genomic extent being displayed in the genomic display area 202. The begin and end positions of scroll bar 207 relative to the underlying chromosome correspond to the left and right edges of the genome area displayed in area 202. If the user “zooms in” the genomic display area 202, the scroll bar 207 would be correspondingly narrower, and if the user would “zoom out”, scroll bar 207 would be correspondingly wider.

According to some embodiments, the user can manipulate the scroll bar 207 to control the “zoom” level. A modified mouse operation (such as a SHIFT or CONTROL key being held down by the user while clicking with the mouse) can be used to change the size of the scroll bar and the corresponding zoom extent in genomic view 202. The modified operation distinguishes the user's intent to change the size of the scroll bar 207 versus simply moving the scroll bar and changing the genomic area as described previously. For example, the user may SHIFT-drag the right edge of scroll bar 207 to a new location in the underlying chromosome and the right edge (and corresponding zoom level) of the genomic display area 202 would be correspondingly updated.

The above-described interactions between the list 200 and the genomic display area 202 permit for convenient access to regions of interest in the genome, and allow for the user to stay informed of the location of the genome that he or she is viewing.

According to some embodiments, the genomic display area 202 includes one or more icons, text labels, or other form of indicia that describe genomic features that are nearby the genomic range presently displayed in the genomic display area 202. For example, the user interface 108 may look for genomic features within ±j bases from the genomic range presented in the display area, where j may be a constant defining a range that is considered “nearby,” or where j may be a value that is scaled based upon the zoom level selected for the scale. For example, assuming a zoom level in which the genomic span presented in the genomic display area is 2000 bases, j may equal 10000, meaning that a genomic feature within 10000 bases of the span presented in the genomic display area is considered nearby, and is therefore indicated with an icon, text label, or other indicia. In the embodiments in which j is scaled according to the zoom level, then if zoom level is adjusted so that the genomic span presented in the genomic display area is 20000 bases, j may equal 100000, and so on.

According to some embodiments, the genomic display area 202 may only display a limited number of icons, text labels, or other form of indicia, based on the area available on the screen, when a large number of features are nearby. In some embodiments, the indicia representing the closest genomic features (in terms of base pair distance) are displayed and the indicia representing genomic features more distant are omitted. In some embodiments, the genomic display area 202 will include a specific icon, text label, or other form of indicia that indicates that some nearby features have been omitted from the list.

According to some embodiments, a gene or region of the genome that has been identified as a region of interest in list 200 may constitute a genomic feature that that is indicated by an icon, text label, or other indicia. For example, the text label 207 reading “GENE2” indicates that a particular gene is located in a nearby upper region of the genome, and the text label 209 reading “HH34” indicates that a region of interest having an identifier of “HH34” is also located in a nearby upper region of the genome. According to some embodiments, an arrow is associated with the label or icon. The arrow indicates the genomic direction of the indicated feature, relative to the genomic span presented in the genomic display area 202. Also, according to some embodiments, the appearance (and/or position) of the text label or icon may vary to indicate how close or far away the indicated feature is from the genomic span presented in the genomic display area. For example, the color of the text label or icon may vary as a function of the proximity of the feature to the presented genomic span. Additionally, the size of the text label or icon may vary as a function of the proximity of the feature to the presented genomic span. In the embodiment depicted in FIG. 2, the text label 207 reading “GENE2” is larger than the text label 209 reading “HH34,” meaning that the gene indicated by the text label 207 is in closer proximity to the presented genomic span than the region of interest indicated by text label 209. Furthermore, the position of the text label or icon may vary to indicate the distance to the indicated feature. For example, in the case of multiple labels or icons representing nearby features, the genomic display 202 may display the icons or labels in vertical order, representing closest to most distant. For example, the icons representing the closest features may be presented at the top of the list.

According to some embodiments, the text label (or icon) 207 may be selectable by the user to quickly navigate to the corresponding nearby feature. For example, if the user selects “GENE2”, item 207 in FIG. 2, the genome display area 202 may navigate directly to a view centered on the genomic feature represented by “GENE2”.

According to some embodiments, the shapes (e.g., bars) that indicate the enrichment of the signal at the various genomic locations may exhibit characteristics that indicate supplemental information. For example, the color, shape, or width of the bars may indicate the average signal intensity of the two signals. (The ratio of signal strengths having a relatively higher average intensity is less affected by noise, and therefore more reliable. This indicator of reliability may be represented by the color, shape or width of the bars indicating the ratio.) For example, as the average of two signals grows greater, the bar indicating their ratio may grow wider, may grow darker in color, or may change shape. The change of a given characteristic with respect to a unit of supplemental information may be either linear or non-linear. Furthermore, thresholding may be applied, so that a given characteristic takes on a particular appearance for all values of supplemental information below a particular threshold or above a particular threshold, and varies—linearly or non-linearly—for values of supplemental information between the thresholds. Another example of supplemental information that may be indicated by the characteristics of the various ratio bars is probe design parameters (such as the melting temperature) of the probes associated with a given genomic region. Still further, the standard deviation (variance, range, or other measure of the tendency of a distribution to vary from its central tendency) of a populace of replicate data is another example of supplemental information. In principle, an enrichment bar may exhibit any number of characteristics, each of which is a function of a like number of supplemental units of information. According to some embodiments, the characteristics that vary as a function of supplemental information are selectable by the user of the interface.

According to some embodiments, the various ratio bars may include error indicators, such as error lines 211 and 213. The signal strengths observed by the reader are subject to error. The user interface may either calculate or be informed of the possible extent of the error, so as to present a first error line 211 that indicates the maximum possible value of the ratio after removal of the error, and to present a second error line 213 that indicates the minimum possible value of the ratio after removal of the error.

According to some embodiments, the genomic display area 202 includes additional text labels, icons, or other indicia to signify regions of interest, identified with a region-of-interest determining algorithm (of which many are known in the art). For example, the hexagonal icon 218 may represent a probe (or set of probes) that is considered significant by such algorithm. Additionally, the hexagonal icon 220 may represent a nearby probe (or set of probes) that is also considered significant. As described previously, the user may select icon 220 to navigate directly to a view centered on the nearby significant probe.

According to some embodiments, the user interface 108 provides detail information concerning an object when the cursor is positioned over the object. For example, when the cursor is located over a particular ratio bar, the information in the second data set 106 may be presented (ID, chromosome, start base number, end base number, log ratio), for example, in a box that appear next to the object over which the cursor is situated. Other information associated with the ratio bar may also be presented, such as the aforementioned supplemental information (e.g., average of signal strengths, or probe design parameters, such as melting temperature of the probes associated with the particular genomic region). Additionally, a hyperlink pointing to information relevant to the object over which the cursor is situated may be presented in the aforementioned box.

According to some embodiments, the user interface 108 includes one or more hyperlinks to information useful to those viewing the genomic data presented therein. For example, hyperlink 115 links to the UCSC Genome Browser. In some embodiments, the hyperlink 115 may refer to specific genomic regions corresponding to the genomic region (chromosome, beginning base pair, ending base pair) being displayed in genomic view 202. When the user selects such a hyperlink, the system may launch a Web browser (as a separate application, or within the genomic view window 202, or within an additional window in the application) displaying the UCSC Genome Browser, with a browser view corresponding (chromosome, begin coordinate, end coordinate) to what is displayed in genomic view 202.

According to some embodiments, the genomic display area 202 includes an adjustable log ratio threshold 217. The user may adjust the threshold 217 by virtue of a click-and-drag operation. Each time the threshold 217 is adjusted, the user interface 108 may provide a numeric description of the value of the threshold, and may also provide a running count of the quantity of ratio bars exceeding and falling short of the threshold 217.

According to some embodiments, tracks from other genome browsers (user interfaces) may be imported and displayed on the user interface 108. For example, BED-format files for the aforementioned UCSC Genome Browser may be imported. The imported track files are aligned with the current genomic view and zoom level. Still further, the user interface 108 may present an embedded view of another genome browser, such as the UCSC Genome Browser, in alignment with the genomic view and zoom level in the genomic display area 202.

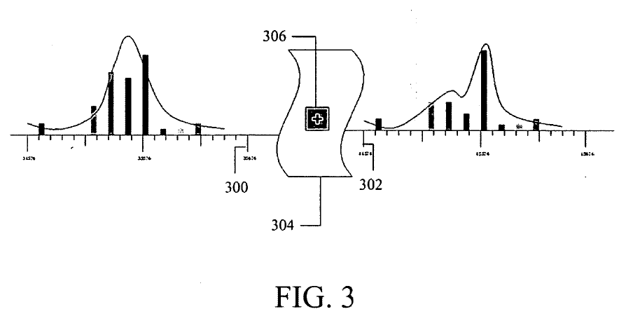

According to some embodiments, the genomic display 202 area allows for certain regions of the genomic view to be collapsed, so as to preserve screen real estate. For example, as shown in FIG. 3, a genomic region between the major tick 300 labeled “35676” and the major tick 302 labeled “44576” has been collapsed, meaning that the data therein is not presented. Instead, a visual indicator 304 of the collapsed region is presented. The visual indicator 304 of the collapsed region includes an expansion button 306. Selection of the expansion button 306 causes the collapsed data to be presented in the genomic view of the genomic display area 202. Upon expansion, the region may be re-collapsed by selection from a pop-up menu, an active display control (e.g., right-click option), or via striking one or more keys, such as a combination of keys, on the keyboard. Further, the user may select a region, and may collapse it, for example, with a right-click option or a keyboard shortcut, as described above.

According to some embodiments, certain regions of the genome are automatically initially collapsed, such as regions of the genome with no probes, no bound sites, no genomic annotations, and/or regions exhibiting centromeres or sequencing gaps. In some embodiments, those regions could be expanded by the user using methods described previously. Other regions may be selected for collapsing, as well, and the visual collapse indicator 304 of the collapsed area may be annotated to indicate the genomic are collapsed. Also, one or more characteristics of the visual collapse indicator 304 may vary as a function of the genomic span of the collapsed region. For example, the width of the visual collapse indicator 304 may vary (linearly or non-linearly) with the span of the collapsed region. The visual collapse indicator may also include a text string indicating the span or approximate span of the collapsed region (e.g., “100000+base pairs).

According to some embodiments, a curve is fit to data presented in the genomic data display area 202. For example a Gaussian curve 222 is fit to data presented in the genomic display area. The Gaussian curve 222 is a probability density function of the genomic location corresponding to an event under study. Thus, the curve 222 identifies a peak. Of course, other curves may be fit to data within the genomic display data area 202, as appropriate given the nature of the data therein. According to some embodiments, the user is provided with an option to override the identification of a peak. In response, the curve 222 may be removed from the genomic data display area 202. Additionally, if a summary report of the data is created, the peak may be removed from the summary report. Still further, the fact that the user disagreed with the identification of the peak may be fed back to an algorithm that identified the peak. The algorithm can then adjust its behavior in light of the knowledge of the disagreement (for example, the algorithm may be a learning algorithm, such as neural network designed to identify peaks, and the neural network may learn from being overridden).

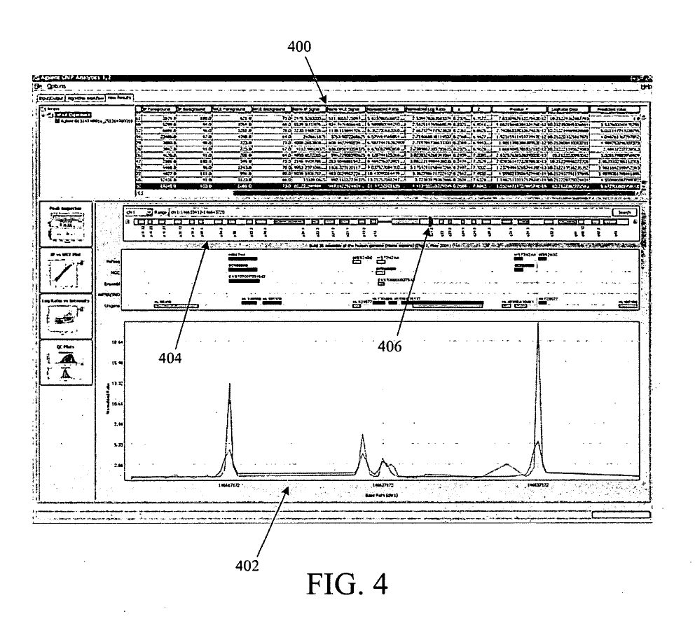

FIG. 4 depicts another embodiment of the user interface. Like the user interface of FIG. 2, the user interface of FIG. 4 includes a list 400 presenting locations of interest, which are highlighted. The user interface also includes a genomic data display area 402. The user interface also includes an elongated bar 404, which serves as a map of the chromosome presently being viewed within the genomic data display area 402. The chromosome map 404 includes a box 406 that identifies the specific region within the chromosome that is being viewed in the genomic data display area 402. According to some embodiments, the box 406 is selectable, and the user may perform a click-and-drag operation with the box, so as to move the box to another location along the chromosome map 404. In response to such a click-and-drag operation, the range of genomic data presented in the genomic data display area 402 changes to correspond with the new location of the box within the chromosome map 404.

Kits for use in connection with the subject invention may also be provided. Such kits preferably include at least a computer readable medium including programming as discussed above and instructions. The instructions may include installation or setup directions. The instructions may include directions for use of the invention with options or combinations of options as described above. In certain embodiments, the instructions include both types of information.

Providing the software and instructions as a kit may serve a number of purposes. The combination may be packaged and purchased as a means of upgrading an existing scanner, computer, or other device for accessing genomic information and presenting the user interface described herein. Alternately, the combination may be provided in connection with a new scanner in which the software is preloaded on the same. In which case, the instructions will serve as a reference manual (or a part thereof and the computer readable medium as a backup copy to the preloaded utility.

The instructions are generally recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or subpackaging), etc. In other embodiments, the instructions are present as an electronic storage data file present on a suitable computer readable storage medium, e.g., CD-ROM, diskette, etc, including the same medium on which the program is presented.

In yet other embodiments, the instructions are not themselves present in the kit, but means for obtaining the instructions from a remote source, e.g. via the Internet, are provided. An example of this embodiment is a kit that includes a web address where the instructions can be viewed and/or from which the instructions can be downloaded. Conversely, means may be provided for obtaining the subject programming from a remote source, such as by providing a web address. Still further, the kit may be one in which both the instructions and software are obtained or downloaded from a remote source, as in the Internet or worldwide web. Some form of access security or identification protocol may be used to limit access to those entitled to use the subject invention. As with the instructions, the means for obtaining the instructions and/or programming is generally recorded on a suitable recording medium.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A computer system for presentation of genomic data, the system comprising:
a processor;
a display in communication with the processor; and
a memory in communication with the processor, the memory storing a set of instructions, which, when executed by the processor, cause the display to present a user interface including a list of locations within a genome that have been identified as being of interest, each listed location being selectable, and a genomic data display area that presents genomic data corresponding to a location selected from said list of locations.

2. The computer system of claim 1, wherein the genomic data comprises a ratio between a first signal and a second signal emitted from probes within a feature corresponding to the select location.

3. The computer system of claim 1, wherein the genomic data display area presents genomic data corresponding to locations in the vicinity of said selected locations.

4. The computer system of claim 1, wherein the genomic data corresponding to the selected location is presented as an icon having a plurality of characteristics, wherein a first characteristic of the icon reveals an enrichment exhibited at the selected genomic location, and wherein a second characteristic of the icon reveals supplemental information about the enrichment exhibited at the selected genomic location.

5. The computer system of claim 4, wherein the icon comprises a bar, and wherein the first characteristic of the icon comprises length, and wherein the second characteristic is color, width, or shape.

6. The computer system of claim 1, wherein the genomic display area includes an indication of a genomic feature that is not presented in the genomic display area, but is in proximity to the selected location, which is presented in the genomic display area.

7. The computer system of claim 6, wherein the genomic feature comprises a gene or a chromosome.

8. The computer system of claim 6, wherein the indication exhibits one or more characteristics, the one or more characteristics being a function of a genomic distance between the selected location and the genomic feature that is not presented in the genomic display area.

9. The computer system of claim 1, wherein the genomic display area further includes a hyperlink to a supplemental source of genomic information.

10. The computer system of claim 1, wherein the genomic display area includes an indication of error that may be included in the genomic data.

11. A computerized method comprising:
presenting a list of genomic locations that have been identified as being of interest, wherein each listed genomic location is selectable;
detecting a selection of a genomic location from the list; and
presenting, in a genomic data display area, genomic data corresponding to the selected genomic location and to genomic locations preceding and following the selected genomic location.

12. The computerized method of claim 11, further comprising:
presenting a scroll bar that controls the set of genomic locations presented in the genomic data display area; and
upon use of the scroll bar that results in a new set of genomic locations presented within the genomic display area, highlighting a genomic location presented within the list of genomic locations of interest, the highlighted genomic location being within the new set of genomic locations.

13. The computerized method of claim 11, further comprising:
providing an adjustable threshold in the genomic display area;
calculating a quantity of genomic data exceeding the threshold or falling short of the threshold; and
presenting the calculated quantities in the genomic display area.

14. The computerized method of claim 11, further comprising:
calculating a curve that best fits at least a portion of the genomic data presented in the genomic display area; and
presenting the curve in the genomic display area, in association with the genomic data to which the curve fits.

15. The computerized method of claim 11, wherein the genomic data corresponding to the selected genomic location is presented as an icon having a plurality of characteristics, wherein a first characteristic of the icon reveals an enrichment exhibited at the selected location, and wherein a second characteristic of the icon reveals supplemental information about the enrichment exhibited at the selected location.

16. The computerized method of claim 15, wherein the supplemental information includes a magnitude of at least one signal from which the enrichment is determined or a characteristic of probes corresponding to the selected genomic location.

17. The computerized method of claim 11, wherein the genomic display area includes an indication of a genomic feature that is not presented in the genomic display area, but is in proximity to the selected genomic location, which is presented in the genomic display area.

18. The computerized method of claim 17, wherein the indication exhibits one or more characteristics, the one or more characteristics being a function of a genomic distance between the selected location and the genomic feature that is not presented in the genomic display area.

19. A computer-readable medium, storing a set of instructions, which when executed by a computer, cause the following acts to be executed:
presenting a list of genomic locations that have been identified as being of interest, wherein each listed genomic location is selectable;
detecting a selection of a genomic location from the list; and
presenting, in a genomic data display area, genomic data corresponding to the selected genomic location and to genomic locations preceding and following the selected genomic location.

20. The computer-readable medium of claim 19, wherein the genomic data corresponding to the selected genomic location is presented as an icon having a plurality of characteristics, wherein a first characteristic of the icon reveals an enrichment exhibited at the selected location, and wherein a second characteristic of the icon reveals supplemental information about the enrichment exhibited at the selected location.

21. A method comprising:
viewing a list of genomic locations that have been identified as being of interest, wherein each listed genomic location is selectable;
selecting a genomic location from the list; and
viewing, in a genomic data display area, genomic data corresponding to the selected genomic location and to genomic locations preceding and following the selected genomic location.

22. The method of claim 21, wherein the genomic data corresponding to the selected genomic location is presented as an icon having a plurality of characteristics, wherein a first characteristic of the icon reveals an enrichment exhibited at the selected location, and wherein a second characteristic of the icon reveals supplemental information about the enrichment exhibited at the selected location.
